(19) United States
(12) Patent Application Publication
(10) Pub. No.: US 2026/0032051 A1
(43) Pub. Date: Jan. 29, 2026

(54) DELEGATING VIRTUALIZATION MANAGEMENT ACTIONS TO NETWORK FUNCTIONS

(71) Applicant: Lenovo (Singapore) Pte. Limited, Singapore (SG)

(72) Inventor: Ishan Vaishnavi, München (DE)

(73) Assignee: Lenovo (Singapore) Pte. Limited, Singapore (SG)

(21) Appl. No.: 18/998,807

(22) PCT Filed: Jul. 26, 2023
(86) PCT No.: PCT/IB2023/057593

§ 371 Date: Jan. 27, 2025

Related U.S. Application Data
(60) Provisional application No. 63/393,222, filed on Jul. 28, 2022.

(51) Int. Cl. H04L 41/0895; H04L 41/026; H04L 41/0816

(52) U.S. Cl. CPC H04L 41/0895; H04L 41/026; H04L 41/0816

(57) ABSTRACT

Various aspects of the present disclosure relate to a network function (NF) that runs on virtual resources that are backed by physical resources on one or more computing devices. The NF receives configuration information from an operations and management entity that indicates to the NF how to request a change (e.g., increase or decrease) in virtual resources assigned to the NF. For example, the configuration information may include an address where the NF is to issue a command to change virtual resources assigned to the NF. The NF determines when one or more conditions for changing the assigned virtual resources are satisfied, and in response issues a command (e.g., to the address indicated in the configuration information) requesting a change in virtual resources assigned to the NF.

### RELATED APPLICATION

This application claims priority to U.S. Patent Application Ser. No. 63/393,222 filed Jul. 28, 2022 entitled “Delegating Virtualization Management Actions to Network Functions,” the disclosure of which is incorporated by reference herein in its entirety.

### TECHNICAL FIELD

The present disclosure relates to wireless communications, and more specifically to delegating virtualization management actions to network functions.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The network communication devices may be supported by one or more network devices running one or more network functions (NFs). A virtualization management entity may work with an operations and management system to provide virtual resources for the NFs to run on the one or more network devices.

### SUMMARY

The present disclosure relates to methods, apparatuses, and systems that support delegating virtualization management actions to network functions. A network function (NF) runs on virtual resources that are backed by physical resources on one or more computing devices. The NF receives configuration information from an operations and management (OAM) entity that indicates to the NF how to request a change (e.g., increase or decrease) in virtual resources assigned to the NF. For example, the configuration information may include an address where the NF is to issue a command to change virtual resources assigned to the NF. The NF determines when one or more conditions for changing the assigned virtual resources are satisfied, and in response issues a command (e.g., to the address indicated in the configuration information) requesting a change in virtual resources assigned to the NF. By having the NF request a change in virtual resources assigned to the NF, the change in virtual resources can happen more quickly than would occur if another entity (such as the OAM) were responsible for determining when to change virtual resources assigned to the NF.

Some implementations of the method and apparatuses described herein may further include a processor; and a memory coupled with the processor, the processor configured to: receive, from an operations and management entity, a first message indicating configuration information for the apparatus, the configuration information including an indication of how to issue one or more requests to effect one or more changes in one or more virtual resources assigned to one or more second apparatus; and issue, in response to one or more conditions being detected, the one or more requests.

In some implementations of the method and apparatuses described herein, the configuration information includes one or more of: an address of a requesting entity where the apparatus sends the one or more requests; authentication details for the apparatus to provide when requesting the one or more changes; and a command to use to request the change. Additionally or alternatively, to issue the one or more requests is to transmit, to a requesting entity, a second message indicating to change a configuration of virtual resources assigned to the one or more second apparatus. Additionally or alternatively, the requesting entity is part of a virtualization management entity. Additionally or alternatively, the configuration information further includes an allowed range for changing the virtual resources. Additionally or alternatively, the configuration information includes the one or more conditions. Additionally or alternatively, the configuration information includes an indication of a source of data, and the processor is further configured to: transmit, to the source of data, a second message requesting first data from the source of data; and determine, based on the first data, whether the one or more conditions are detected. Additionally or alternatively, the source of data comprises the operations and management entity. Additionally or alternatively, the processor is further configured to: transmit, to the operations and management entity, a second message requesting virtualization access for the apparatus; and receive, from the operations and management entity in response to the second message, the first message indicating configuration information for the apparatus.

Some implementations of the method and apparatuses described herein may further include a processor; and a memory coupled with the processor, the processor configured to: generate configuration information for a first device, the configuration information including an indication of how to issue one or more requests to effect one or more change in one or more virtual resources assigned to a second device; and transmit, to the first device, a first message indicating the configuration information for the first device.

In some implementations of the method and apparatuses described herein, the configuration information includes one or more of: an address of a requesting entity where the first device sends the one or more requests; and authentication details for the first device to provide when requesting the one or more changes. Additionally or alternatively, the processor is further configured to: transmit, to the requesting entity, a second message mapping the request to a corresponding virtualization management entity, the second message further including: authorization details for the requesting entity; an allowed range for changing virtual resources; and an identifier of the virtualization management entity. Additionally or alternatively, the configuration information includes an allowed range for changing the virtual resources. Additionally or alternatively, the configuration information includes one or more conditions for the first device to use to determine when to issue the one or more requests. Additionally or alternatively, the processor is further configured to: receive, from the first device, a second message requesting data for the first device to determine whether to issue the one or more requests; and transmit, to the first device, the data. Additionally or alternatively, the processor is further configured to: receive, from the first device, a second message requesting virtualization access for the first device; and transmit, to the first device, the first message indicating configuration information for the first device.

### BRIEF DESCRIPTION OF THE DRAWINGS

FIG. 1 illustrates an example of a wireless communications system that supports delegating virtualization management actions to network functions in accordance with aspects of the present disclosure.

FIG. 2 illustrates an example of a system that supports delegating virtualization management actions to network functions in accordance with aspects of the present disclosure.

FIG. 3 illustrates an example of a system that supports delegating virtualization management actions to network functions in accordance with aspects of the present disclosure.

FIG. 4 illustrates an example of a sequence diagram in accordance with aspects of the present disclosure.

FIGS. 5 and 6 illustrate examples of block diagrams of devices that support delegating virtualization management actions to network functions in accordance with aspects of the present disclosure.

FIGS. 7 through 11 illustrate flowcharts of methods that support delegating virtualization management actions to network functions in accordance with aspects of the present disclosure.

### DETAILED DESCRIPTION

Different control plane NFs may at different time need management plane functionalities. One issue addressed herein is that of load. An NF, for example a session management function (SMF), may experience a high load condition such that it is using 80 to 90% of its assigned virtual resources. One solution is to have the OAM in such a case detect a high load and assign more virtual resources to the SMF. However, in some cases this may result in low performance of the SMF until the OAM responds and in some networks, such as low latency networks, the response from the NF (SMF in this case) could be very slow. The same holds true for a network data analytics function (NWDAF), which may deny analytics requests, or overloaded network slices that may deny user equipment (UE) service requests until the OAM detects and responds to improve their configuration. This results in the control plane NFs being unable to react to bursts in requests over a short time frame.

An NF runs on virtual resources that are backed by physical resources on one or more computing devices. These virtual resource may be, for example, containers or virtual machines. A container includes at least one application as well as libraries, frameworks, dependencies, other binaries, configuration files, and so forth used to run the at least one application. Each container on a device shares the host operating system kernel with the other containers on the device. A virtual machine includes at least one application as well as an operating system and any associated libraries, binaries, and so forth. A hypervisor (also referred to as a virtual machine monitor) is situated between the hardware of the computing device and the virtual machines running on the computing device virtualizes the computing device and creates and runs the virtual machines.

An OAM entity (also referred to as simply an OAM) transmits, to the NF, configuration information that indicates to the NF how to request a change (e.g., increase or decrease) in virtual resources assigned to the NF. Various information may be included in the configuration information, such as an address of a receiving entity for a command requesting to change virtual resources assigned to the NF, the commands that may be used to request a change in virtual resources assigned to the NF (e.g., a scale up command to increase the virtual resources assigned to the NF (e.g., by assigning a new container or virtual machine to the NF), a scale down command to decrease the virtual resources assigned to the NF (e.g., by unassigning a container or virtual machine to the NF, which may then be deleted or assigned to another NF), authentication (also referred to as authorization) details for the NF to use or provide when issuing a command requesting a change in virtual resources assigned to the NF, and so forth.

The NF determines when one or more conditions for changing the assigned virtual resources are satisfied. These one or more conditions may be received, for example, from the OAM entity as part of the configuration information. Data used to determine whether the one or more conditions are satisfied may be received from any of various sources, such as the OAM, another NF, a network slice instance (NSI), a managed entity (ME), and so forth. The NF, in response to determining that the one or more conditions are satisfied, issues a command (e.g., to the address indicated in the configuration information) requesting a change in virtual resources assigned to the NF. A virtualization management entity responds to the command by changing the virtual resources assigned to the NF in accordance with the command.

The techniques discussed herein configure the NF to determine when to request a change in virtual resources assigned to the NF and to request that change rather than having a management entity (such as the OAM) determine when to request a change to virtual resources assigned to the NF. This allows the change in virtual resources assigned to the NF to be performed more quickly because the OAM works slower than the NF, so the NF can determine when to request a change in virtual resources assigned to the NF more quickly than the OAM can. Furthermore, by having the change in virtual resources assigned to the NF performed quickly, the performance of the NF may be improved since it has the virtual resources it needs sooner, and service requests that may have otherwise been denied (e.g., due to the NF having insufficient virtual resources) may be granted because the NF has the virtual resources it needs sooner.

By having the NF request a change in virtual resources assigned to the NF, the change in virtual resources can happen more quickly than would occur if another entity (such as the OAM) were responsible for determining when to change virtual resources assigned to the NF. Having a management entity (e.g., the OAM) delegate a set of virtualization related management actions to the individual control plane NFs enables the NFs to take faster actions in terms of virtualization resource management and alleviates the load on the management entity (e.g., the OAM) to do so. This increases the response time of the NFs to load situations and thereby improves both quality of experience (QoE) and the energy efficiency.

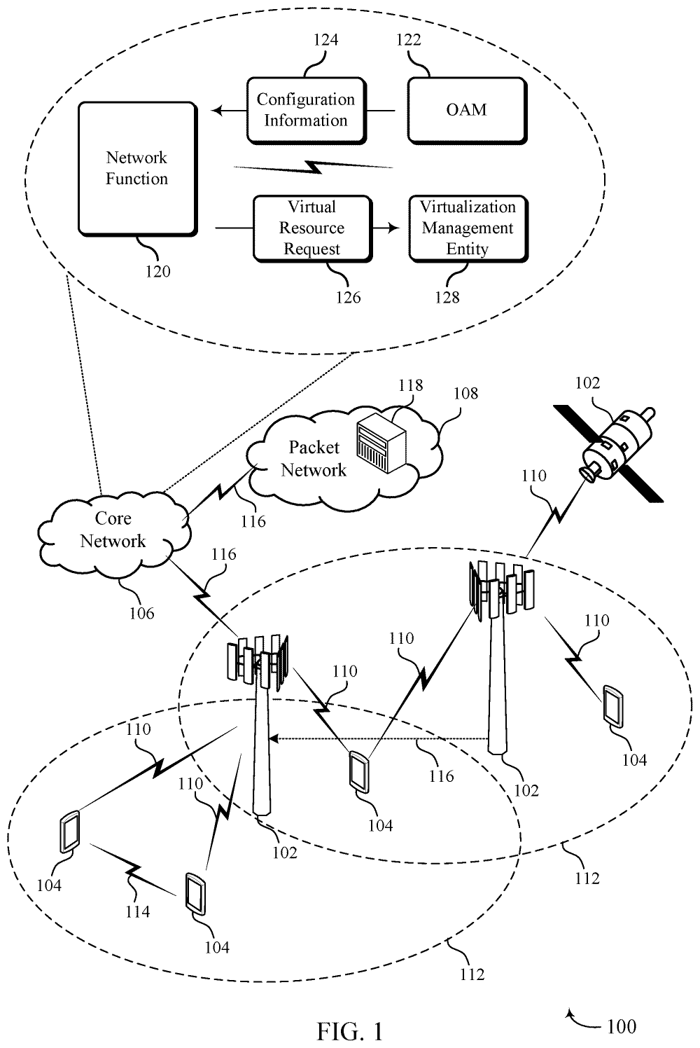

FIG. 1 illustrates an example of a wireless communications system 100 that supports delegating virtualization management actions to network functions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As discussed above, the core network 106 may support user authentication, access authorization, tracking, connectivity, and other access, routing, or mobility functions. The core network includes various different NFs to support these various activities. A NF 120 is illustrated and may support any one or more of user authentication, access authorization, tracking, connectivity, other access, routing, or mobility functions, and so forth. An OAM 122 provides configuration information 124 to the NF 120, the configuration information indicating to the NF 120 how to request a change in virtual resources assigned to the NF 120. This request may be to increase in virtual resources assigned to the NF 120 (also referred to as a scale up command or a scale out command), to decrease in virtual resources assigned to the NF 120 (also referred to as a scale down command or a scale in command), to change a software version, to migrate, to reallocate an Internet protocol (IP) address, or any other configuration or management command of a virtual entity. Various information may be included in the configuration information 124, such as an address of a receiving entity for a command requesting to change virtual resources assigned to the NF 120, the commands that may be used to request changes in virtual resources assigned to the NF 120 (e.g., a scale up command to increase the virtual resources assigned to the NF, a scale down command to decrease the virtual resources assigned to the NF 120), authentication details for the NF 120 to use or provide when issuing a command requesting a change in virtual resources assigned to the NF 120, and so forth.

The NF 120 determines when one or more conditions for changing the assigned virtual resources are satisfied. These one or more conditions may be received, for example, from the OAM 122 as part of the configuration information 124. Data used to determine whether the one or more conditions are satisfied may be received from any of various sources, such as the OAM 122, another NF, an NSI, an ME, and so forth. The NF 120, in response to determining that the one or more conditions are satisfied, issues a virtual resource request 126 (e.g., to the address indicated in the configuration information 124) requesting a change in virtual resources assigned to the NF 120. A virtualization management entity 128 responds to the command by changing the virtual resources assigned to the NF 120 in accordance with the virtual resource request 126.

FIG. 2 illustrates an example of a system 200 that supports delegating virtualization management actions to network functions in accordance with aspects of the present disclosure. The system includes three layers: a management plane with an OAM 202, a control plane (CP) with at least one CP NF 204, and a user plane (UP) with one or more UP NFs 206. The UP may also be referred to as a data plane (DP). A UE 208 maintains a CP connection to the CP NF 204, and a DP connection to the UP NFs 206.

The OAM 202 of the management plane is responsible for the function of the network, infrastructure, and the entire telecommunications system (e.g., the wireless communications system 100 of FIG. 1). The control plane is responsible for individual or limited group management of connections in the user plane. Typically, the control plane sets up the user or data plane connections requested by one or a group of users. Additionally, the system 200 embraces virtualization, which means that all of the control plane and the user plane may be hosted on a virtualized infrastructure. The virtualized infrastructure is managed by a virtualization management entity 210, which is illustrated in FIG. 2 as generating a virtual dual 212 of a CP NF and a virtual dual 214 of a UP NF. These virtual duals 212 and 214 are generated, for example, in response to a request from a NF for an increase in virtual resources assigned to the NF.

One solution for requesting a change in virtual resources assigned to the NF is for the OAM 202 to monitor the load of the NF and request additional virtual resources in case the NF is heavily loaded to the European Telecommunications Standards Institute (ETSI) network function virtualization (NFV) system. This is a slow process as the OAM 202 typically works at a slower time granularity than the control plane may require.

For example, currently the NWDAF (an example of a NF) may cancel a subscription because of overload. For each Analytics ID the Termination Request, which notifies the consumer that the subscription is requested to be cancelled as the NWDAF can no longer serve this subscription, e.g., due to user consent revoked, NWDAF overload, UE moved out of NWDAF serving area, etc. Accordingly, the NWDAF may terminate a request when it thinks it doesn't have enough resources. This may affect the quality of function of the control and data planes.

Similar examples of overload could extend beyond the NWDAF, for example when an ultra-reliable low latency communications (URLLC) connection is requested by a UE to a loaded SMF or UP NF there may be delay in handling the connection. Or, when the NWDAF expects a burst in UE requests temporarily there is no way a control plane NF can currently react to such a request except the access & mobility management function (AMF) dropping UE requests. This could further be extended to the overload of not only NFs overload but an entire NSI or a network slice subnet instance (NSSI). Furthermore, it could also be extended to not only managing the load, but also other options related to virtualization as need be.

Using the techniques discussed herein, the situations where overload occur are reduced because the NF is able to determine that additional virtual resources are needed and issue a request to have those additional virtual resources assigned to the NF faster than the OAM 202 would be able to detect the need for additional virtual resources and have those additional virtual resources assigned to the NF.

The NFs themselves may be more quickly aware of their own load situation than the OAM 202. Thus the NFs are enabled by the OAM 202 to transmit a request for a change in virtual resources directly to the OAM 202 or to the virtualization management entity 210. In the NWDAF overload example above, instead of cancelling the request the OAM 202 could assign more virtual resources to the NWDAF. This, however, is a long term solution not suitable in case of bursts of load over a short time period.

The OAM 202 configures the NF with a specific address and corresponding authentication details where the NF can request a list of pre-determined actions. For example, an SMF may want to scale up a given set of resources for itself or for a particular UP NF. A policy control function (PCF) may scale up virtual resources for an AMF or an NWDAF. An NWDAF may want to scale up its own resources prior to performing certain analytic operations or those of analytical logical function (AnLF) or model training logical function (MTLF) or for those of an entire network slice.

In one or more implementations, the specific address is in the OAM 202 itself. In this case the ability of the NF to transmit a request for a change in virtual resources to the OAM 202 is supported. Additionally or alternatively, the specific address is in the virtualization management entity 210. In this case the NF can directly request a change in virtual resources from the virtual machine management without necessary involving the OAM 202, which is much faster than going through the OAM 202.

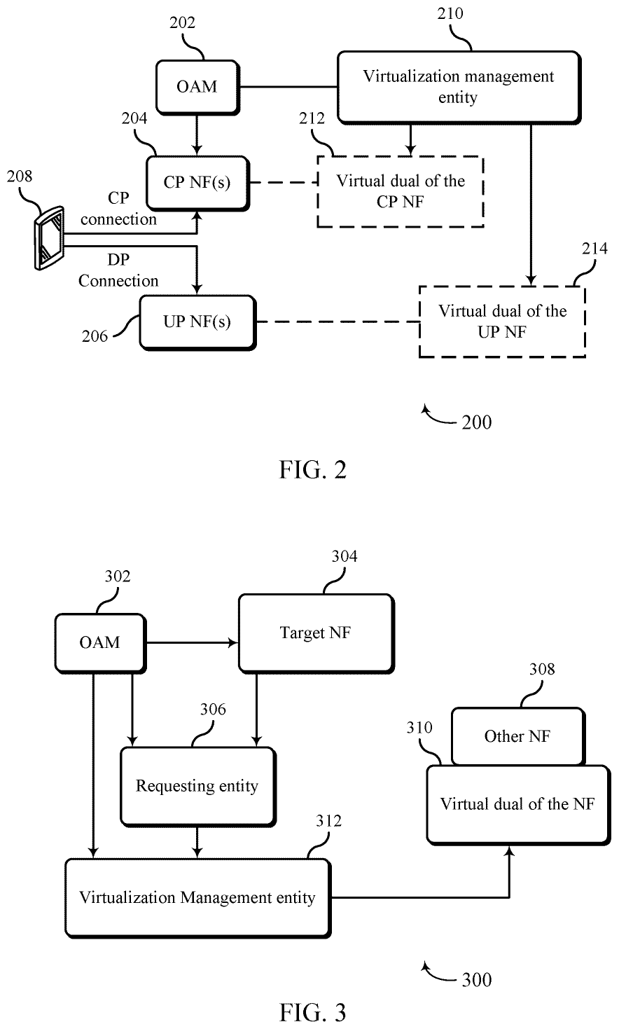

FIG. 3 illustrates an example of a system 300 that supports delegating virtualization management actions to network functions in accordance with aspects of the present disclosure. The system 300 includes an OAM 302, a target NF 304, a requesting entity 306, an other NF 308, a virtual dual 310 of the other NF 308, and a virtualization management entity 312. The OAM 302 is an OAM as discussed above, a management system, or a management service producer. The target NF 304 is a NF that is to be configured to allow for access to management plane functionalities. The target NF 304 is any NF defined by 3GPP SA2 group.

The requesting entity 306 is the entity that receives the request to manage the virtualization aspects that the target NF 304 wants to change. The requesting entity 306 could be the virtualization manager (e.g., the virtualization management entity 312), the OAM 302, a hypertext transfer protocol (HTTP) webserver, a remote procedure call (RPC) server, or any other entity that can directly or indirectly manage the virtual dual 310 of the other NF 308.

The other NF 308 is another NF whose virtualization related resources are being changed. In some situations the other NF 308 can be the target NF 304 itself. Although illustrated as an NF, the other NF 308 may be an NSI or ME. Accordingly, the target NF 304 may request a change in virtual resources assigned to the target NF 304 itself or to another NF (e.g., a user plane NF).

The virtual dual 310 of the other NF 308 is the corresponding virtual entity that the other NF 308 runs on. For an NF this could be a corresponding virtual network function (VNF), a container, or any sort of virtualization or containerization-based software. For an NSI or NSSI the virtual dual 310 of the other NF 308 can be the network service (NS), which is defined by ETSI NFV. Similarly, for other managed entities there could be virtualized or containerized entity that they are hosted on. Although illustrated as a virtual dual 310 of the other NF 308, the virtual dual 310 may be a virtual dual of an NSI or ME.

The virtualization management entity 312 refers to the management system that manages the virtualization aspect which could be any one or more of ETSI NFV based management system (e.g., network functions virtualization orchestration (NFVO) or virtual network functions manager (VNFM)), virtual machines, hypervisors, and containers.

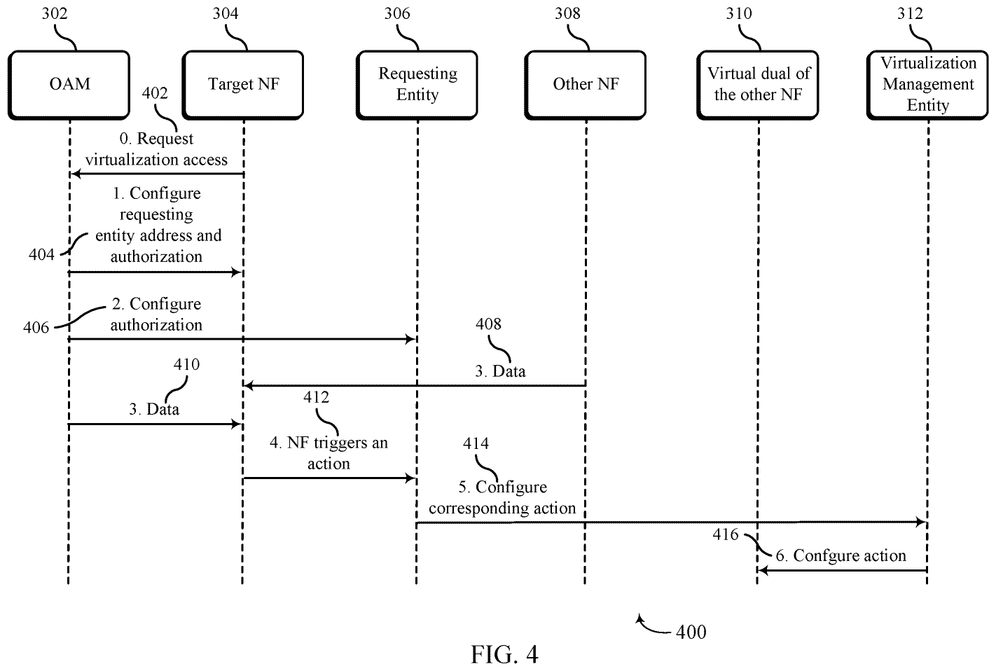

FIG. 4 illustrates an example of a sequence diagram 400 in accordance with aspects of the present disclosure. The discussion of the sequence diagram 400 refers back to components in FIGS. 1-3.

At 402, the target NF 304 optionally requests (e.g., by transmitting a signaling to the OAM 302) access to certain aspects of its virtualization control. This includes, for example, scaling up its virtual dual, scaling down its virtual dual, or any other possible management configuration that can be performed on the virtual dual.

At 404, the OAM 302 configures the target NF 304 with, for each of one or more commands, the command corresponding to an action the target NF 304 can execute (e.g., to request a change in virtual resources assigned to the target NF 304) and optionally the corresponding conditions under which to execute them. For example, the target NF 304 can be configured to execute a scale up command when its usage passes 20,000 connections. By way of another example, the target NF 304 can be configured to execute scale down commands when the utilization is below 20%. In one or more implementations, the configuration includes any combination of the address where the target NF 304 is to issue the command, the protocol to use, the authentication details to provide when executing the command, the data sources used to support and monitor the condition, and allowed range for each command where applicable. The allowed range indicates boundaries or limits on what the target NF 304 may request. For example, amounts of virtual resources may be separated into groupings of low, medium, high, or very high, and the allowed range may indicate that the target NF 304 may request changes to virtual resources only up to a high amount of virtual resources. In such situations, requesting changes to virtual resources that is outside of the allowed range is handled by another entity (e.g., the OAM 302). The data source could be the other NF 308, the target NF 304 itself, another NF, the OAM 302, or any data available in the environment. In case the target NF 304 has requested the virtualization access then the target NF 304 may have its own internal considerations on when to execute the action.

In one or more implementations, the OAM 302 configures the target NF 304 with a policy that indicates for the target NF 304 to monitor particular data and take one or more particular actions based on the particular data. Additionally or alternatively, the OAM 302 configures the target NF 304 to take a particular action (e.g., scale up) and the target NF 304 understands what that particular action is. Accordingly, the target NF 304 may know to monitor particular data and issue the scale up command when the data indicates a particular state (e.g., usage greater than 20,000 connections).

This configuring of the target NF 304 is performed, for example, by the OAM 302 transmitting a signaling to the target NF 304 that includes configuration information that describes this configuring of the target NF 304.

At 406, the OAM 302 optionally configures the requesting entity 306 that the target NF 304 is allowed to send requests for the other NF virtual dual 310. This may include configuring the virtualization management entity 312 that the requesting entity 306 is supposed to use per command from the target NF 304 (e.g., configuring the requesting entity 306 with an identifier of the virtualization management entity 312, effectively mapping the requesting entity 306 to one or more virtualization management entities 312 on a per-command basis), and the corresponding command at the virtualization management entity 312. This may further include authorization details for the requesting entity 306 (e.g., authorization or authentication information to access the virtualization management entity 312), an allowed range for changing virtual resources for the requesting entity 306, and so forth. By way of example, when the target NF 304 requests scale up for the other NF 308, the requesting entity 306 contacts the virtualization management entity 312 or the virtual dual at the configured address (e.g., IP address) and issue a command “increase virtual machine (VM) to high end VM”. The requesting entity 306 may be a part of the virtualization management entity 312 or the virtual dual 310 of the other NF.

At 408 and 410, based on the data source configured at 404, the target NF 304 may request and receive respective data from the list of provided data sources. E.g., this data may be received from the other NF 308 or from the OAM 302 (or other sources as discussed above).

At 412, based on the data, when a condition is met, the target NF 304 triggers an action to, for example, scale up the virtual dual 310 of the other NF. The target NF 304 triggers the action by transmitting (e.g., issuing) a command or request to the address indicated in the configuration information received at 404, which is an address of the requesting entity 306.

At 414, based on configurations at 406, the requesting entity 306 transfers the translated request to the virtualization management entity 312.

It should be noted that in situations where the target NF 304 is the other NF 308, the triggering of the action at 412 and the transferring the request to the virtualized management entity at 414 may be combined. For example, at 412 the target NF 304 triggers the action by transmitting a command or request to the address indicated in the configuration information received at 404, which is an address of the virtualization management entity 312.

At 416, the virtualization management entity correspondingly configures the virtual dual 310 of the other NF. This configuring at 416 is changing the virtual resources assigned to the target NF 304 in accordance with command or request from the target NF 304 at 412. As noted above, in some situations the other NF 308 is the target NF 304 itself, in which case the virtual dual 310 is a virtual dual of the target NF 304.

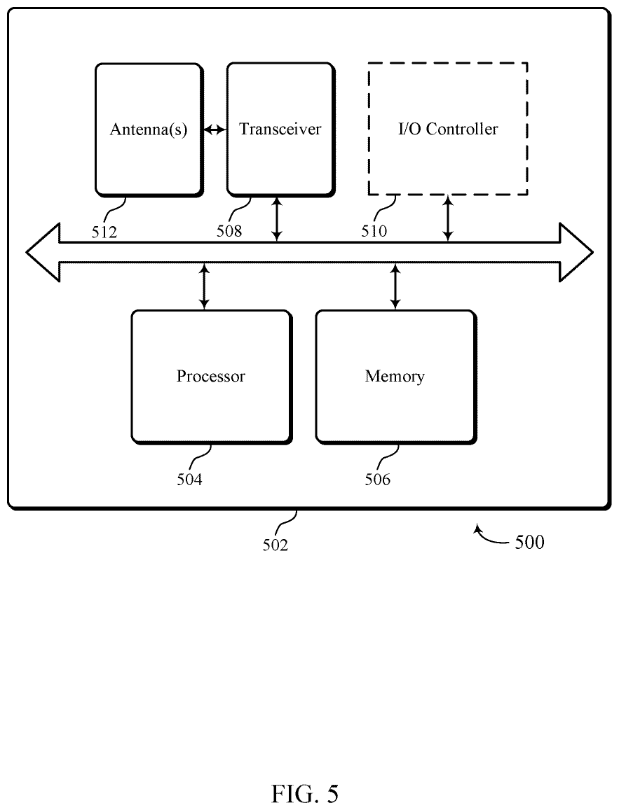

FIG. 5 illustrates an example of a block diagram 500 of a device 502 that supports delegating virtualization management actions to network functions in accordance with aspects of the present disclosure. The device 502 may be an example of a network entity that is a device in the core network 106 (e.g., a computing device implementing a NF) as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. Processor 504 may be configured to or otherwise support receive, from an operations and management entity, a first message indicating configuration information for the apparatus, the configuration information including an indication of how to issue one or more requests to effect one or more changes in one or more virtual resources assigned to one or more second apparatus; and issue, in response to one or more conditions being detected, a command to request the change in virtual resources assigned to the apparatus.

Additionally or alternatively, the processor 504 may be configured to or otherwise support: where the configuration information includes one or more of: an address of a requesting entity where the apparatus sends the one or more requests; authentication details for the apparatus to provide when requesting the one or more changes; and a command to use to request the change; where to issue the one or more requests is to transmit, to a requesting entity, a second message indicating to change a configuration of virtual resources assigned to the one or more second apparatus; where the requesting entity is part of a virtualization management entity; where the configuration information further includes an allowed range for changing the virtual resources; where the configuration information includes the one or more conditions; where the configuration information includes an indication of a source of data, and further transmit, to the source of data, a second message requesting first data from the source; and determine, based on the first data, whether the one or more conditions are detected; where the source of data comprises the operations and management entity; transmit, to the operations and management entity, a second message requesting virtualization access for the apparatus; and receive, from the operations and management entity in response to the second message, the first message indicating configuration information for the apparatus.

For example, the processor 504 may support wireless communication at the device 502 in accordance with examples as disclosed herein. Processor 504 may be configured as or otherwise support a means for receiving, from an operations and management entity, a first message indicating configuration information for an apparatus implementing the method, the configuration information including an indication of how to issue one or more requests to effect one or more changes in one or more virtual resources assigned to one or more second apparatus; and issuing, in response to one or more conditions being detected, the one or more requests.

Additionally or alternatively, the processor 504 may be configured as or otherwise support: where the configuration information includes one or more of: an address of a requesting entity where the apparatus sends the one or more requests; authentication details for the apparatus to provide when requesting the one or more changes; and a command to use to request the change; where issuing the one or more requests comprises transmitting, to a requesting entity, a second message indicating to change a configuration of virtual resources assigned to the one or more second apparatus; where the requesting entity is part of a virtualization management entity; where the configuration information further includes an allowed range for changing virtual resources; where the configuration information includes the one or more conditions; where the configuration information includes an indication of a source of data, and the method further including: transmitting, to the source of data, a second message requesting request first data from the source of data; and determining, based on the first data, whether the one or more conditions are detected; where the source of data comprises the operations and management entity; transmitting, to the operations and management entity, a second message requesting virtualization access for the apparatus; and receiving, from the operations and management entity in response to the second message, the first message indicating configuration information for the apparatus.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor M06. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

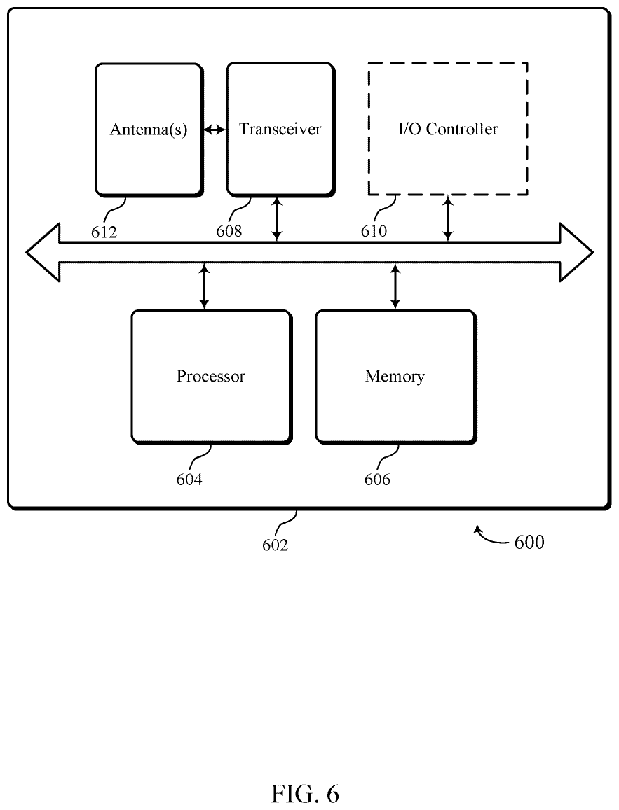

FIG. 6 illustrates an example of a block diagram 600 of a device 602 that supports delegating virtualization management actions to network functions in accordance with aspects of the present disclosure. The device 602 may be an example of network entity that is a device in the core network 106 (e.g., a computing device implementing an OAM) as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured to or otherwise support generate configuration information for a first device, the configuration information including an indication of how to issue one or more requests to effect one or more changes in one or more virtual resources assigned to a second device; and transmit, to the first device, a first message indicating the configuration information for the first device.

Additionally or alternatively, the processor 604 may be configured as or otherwise support: where the configuration information includes one or more of: an address of a requesting entity where the first device sends the one or more requests; and authentication details for the first device to provide when requesting the one or more changes; transmit, to the requesting entity, a second message mapping the request to a corresponding virtualization management entity, the second message further including: authorization details for the requesting entity; an allowed range for changing virtual resources; and an identifier of the virtualization management entity; where the configuration information includes an allowed range for changing the virtual resources; where the configuration information includes one or more conditions for the first device to use to determine when to issue the one or more requests; receive, from the first device, a second message requesting data for the first device to determine whether to issue the one or more requests; and transmit, to the first device, the data; receive, from the first device, a second message requesting virtualization access for the first device; and transmit, to the first device, the first message indicating configuration information for the first device.

For example, the processor 604 may support wireless communication at the device 602 in accordance with examples as disclosed herein. Processor 604 may be configured as or otherwise support a means for generating configuration information for a first device, the configuration information including an indication of how to issue one or more requests to effect one or more changes in one or more virtual resources assigned to a second device; and transmitting, to the first device, a first message indicating the configuration information for the first device.

Additionally or alternatively, the processor 604 may be configured to or otherwise support: where the configuration information includes one or more of: an address of a requesting entity where the first device sends the one or more requests; and authentication details for the first device to provide when requesting the one or more changes; transmitting, to the requesting entity, a second message mapping the request to a corresponding virtualization management entity, the second message further including: authorization details for the requesting entity; an allowed range for increasing or decreasing virtual resources; and an identifier of the virtualization management entity; where the configuration information includes an allowed range for changing the virtual resources; where the configuration information includes one or more conditions for the first device to use to determine when to issue the one or more requests; receiving, from the first device, a second message requesting data for the first device to determine whether to issue the one or more requests; and transmitting, to the first device, the data; receiving, from the first device, a second message requesting virtualization access for the first device; and transmitting, to the first device, the first message indicating configuration information for the first device.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor M06. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

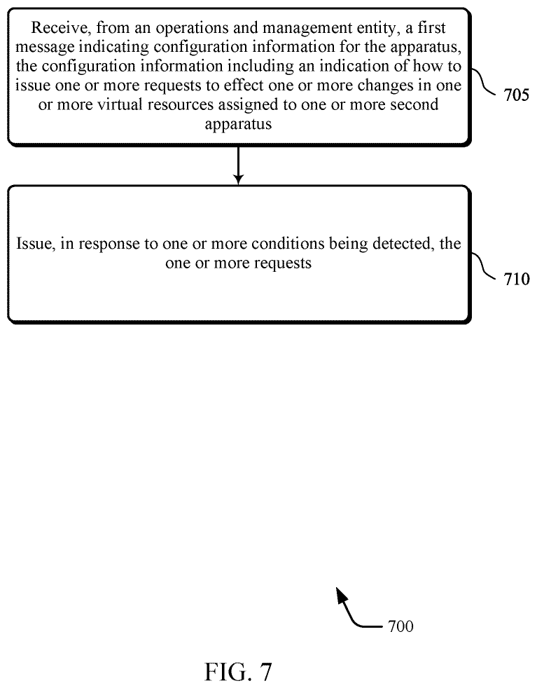

FIG. 7 illustrates a flowchart of a method 700 that supports delegating virtualization management actions to network functions in accordance with aspects of the present disclosure. The operations of the method 700 may be implemented by a device or its components as described herein. For example, the operations of the method 700 may be performed by a device in the core network 106 (e.g., a computing device implementing a NF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 705, the method may include receiving, from an operations and management entity, a first message indicating configuration information for the apparatus, the configuration information including an indication of how to issue one or more requests to effect one or more changes in one or more virtual resources assigned to one or more second apparatus. The operations of 705 may be performed in accordance with examples as described herein. In some implementations, aspects of the operations of 705 may be performed by a device as described with reference to FIG. 1.

At 710, the method may include issuing, in response to one or more conditions being detected, the one or more requests. The operations of 710 may be performed in accordance with examples as described herein. In some implementations, aspects of the operations of 710 may be performed by a device as described with reference to FIG. 1.

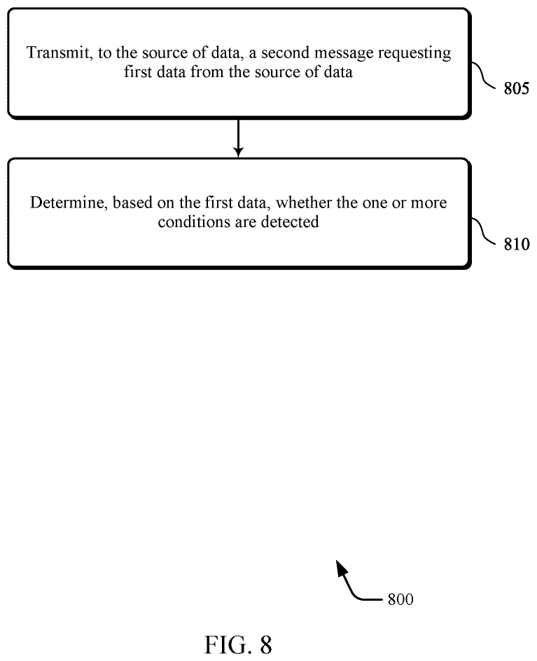

FIG. 8 illustrates a flowchart of a method 800 that supports delegating virtualization management actions to network functions in accordance with aspects of the present disclosure. The operations of the method 800 may be implemented by a device or its components as described herein. For example, the operations of the method 800 may be performed by a device in the core network 106 (e.g., a computing device implementing a NF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include transmit, to the source of data, a second message requesting first data from the source of data. The operations of 805 may be performed in accordance with examples as described herein. In some implementations, aspects of the operations of 805 may be performed by a device as described with reference to FIG. 1.

At 810, the method may include determining, based on the first data, whether the one or more conditions are detected. The operations of 810 may be performed in accordance with examples as described herein. In some implementations, aspects of the operations of 810 may be performed by a device as described with reference to FIG. 1.

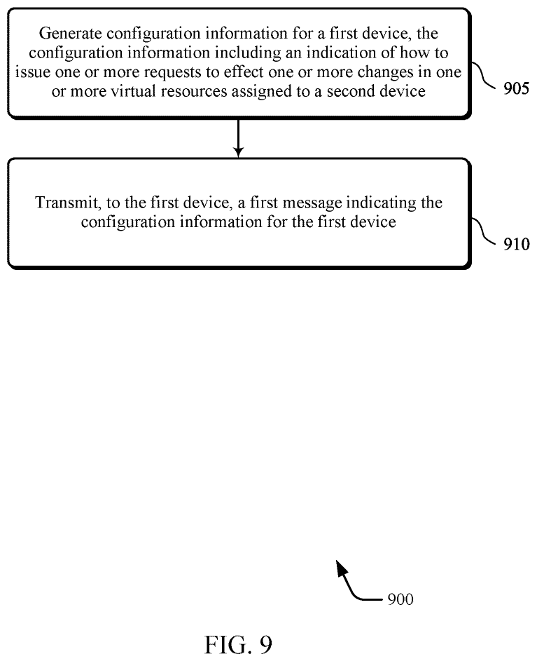

FIG. 9 illustrates a flowchart of a method 900 that supports delegating virtualization management actions to network functions in accordance with aspects of the present disclosure. The operations of the method 900 may be implemented by a device or its components as described herein. For example, the operations of the method 900 may be performed by a device in the core network 106 (e.g., a computing device implementing an OAM) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 905, the method may include generating configuration information for a first device, the configuration information including an indication of how to issue one or more requests to effect one or more changes in one or more virtual resources assigned to a second device. The operations of 905 may be performed in accordance with examples as described herein. In some implementations, aspects of the operations of 905 may be performed by a device as described with reference to FIG. 1.

At 910, the method may include transmitting, to the first device, a first message indicating the configuration information for the first device. The operations of 910 may be performed in accordance with examples as described herein. In some implementations, aspects of the operations of 910 may be performed by a device as described with reference to FIG. 1.

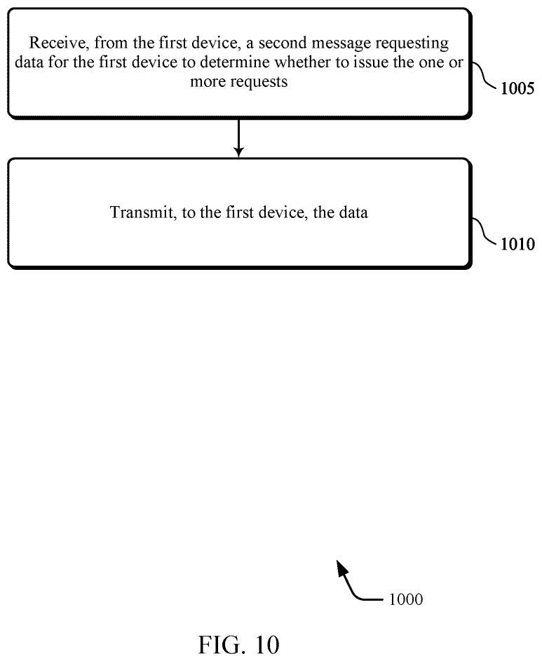

FIG. 10 illustrates a flowchart of a method 1000 that supports delegating virtualization management actions to network functions in accordance with aspects of the present disclosure. The operations of the method 1000 may be implemented by a device or its components as described herein. For example, the operations of the method 1000 may be performed by a device in the core network 106 (e.g., a computing device implementing an OAM) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1005, the method may include receiving, from the first device, a second message requesting data for the first device to determine whether to issue the one or more requests. The operations of 1005 may be performed in accordance with examples as described herein. In some implementations, aspects of the operations of 1005 may be performed by a device as described with reference to FIG. 1.

At 1010, the method may include transmitting, to the first device, the data. The operations of 1010 may be performed in accordance with examples as described herein. In some implementations, aspects of the operations of 1010 may be performed by a device as described with reference to FIG. 1.

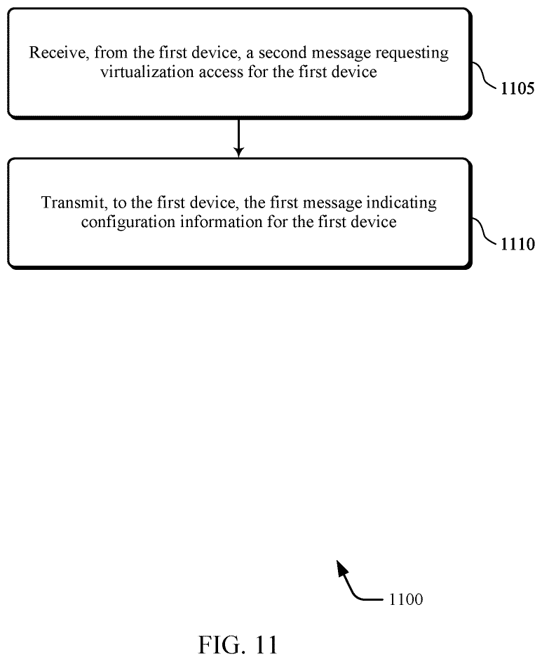

FIG. 11 illustrates a flowchart of a method 1100 that supports delegating virtualization management actions to network functions in accordance with aspects of the present disclosure. The operations of the method 1100 may be implemented by a device or its components as described herein. For example, the operations of the method 1100 may be performed by a device in the core network 106 (e.g., a computing device implementing an OAM) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1105, the method may include receiving, from the first device, a second message requesting virtualization access for the first device. The operations of 1105 may be performed in accordance with examples as described herein. In some implementations, aspects of the operations of 1105 may be performed by a device as described with reference to FIG. 1.

At 1110, the method may include transmitting, to the first device, the first message indicating configuration information for the first device. The operations of 1110 may be performed in accordance with examples as described herein. In some implementations, aspects of the operations of 1110 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
a processor; and
a memory coupled with the processor, the processor configured to:
receive, from an operations and management entity, a first message indicating configuration information for the apparatus, the configuration information including an indication of how to issue one or more requests to effect one or more changes in one or more virtual resources assigned to one or more second apparatus; and
issue, in response to one or more conditions being detected, the one or more requests.

2. The apparatus of claim 1, wherein the configuration information includes one or more of:
an address of a requesting entity where the apparatus sends the one or more requests;
authentication details for the apparatus to provide when requesting the one or more changes; and
a command to use to request the change.

3. The apparatus of claim 1, wherein to issue the one or more requests is to transmit, to a requesting entity, a second message indicating to change a configuration of virtual resources assigned to the one or more second apparatus.

4. The apparatus of claim 3, wherein the requesting entity is part of a virtualization management entity.

5. The apparatus of claim 1, wherein the configuration information further includes an allowed range for changing the virtual resources.

6. The apparatus of claim 1, wherein the configuration information includes the one or more conditions.

7. The apparatus of claim 1, wherein the configuration information includes an indication of a source of data, and wherein the processor is further configured to:
transmit, to the source of data, a second message requesting first data from the source of data; and
determine, based on the first data, whether the one or more conditions are detected.

8. The apparatus of claim 7, wherein the source of data comprises the operations and management entity.

9. The apparatus of claim 1, wherein the processor is further configured to:
transmit, to the operations and management entity, a second message requesting virtualization access for the apparatus; and
receive, from the operations and management entity in response to the second message, the first message indicating configuration information for the apparatus.

10. An apparatus for wireless communication, comprising:
a processor; and
a memory coupled with the processor, the processor configured to:
generate configuration information for a first device, the configuration information including an indication of how to issue one or more requests to effect one or more changes in one or more virtual resources assigned to a second device; and
transmit, to the first device, a first message indicating the configuration information for the first device.

11. The apparatus of claim 10, wherein the configuration information includes one or more of:
an address of a requesting entity where the first device sends the one or more requests; and
authentication details for the first device to provide when requesting the one or more changes.

12. The apparatus of claim 11, wherein the processor is further configured to:
transmit, to the requesting entity, a second message mapping the request to a corresponding virtualization management entity, the second message further including:
authorization details for the requesting entity;
an allowed range for changing virtual resources; and
an identifier of the virtualization management entity.

13. The apparatus of claim 10, wherein the configuration information includes an allowed range for changing the virtual resources.

14. The apparatus of claim 10, wherein the configuration information includes one or more conditions for the first device to use to determine when to issue the one or more requests.

15. The apparatus of claim 10, wherein the processor is further configured to:
receive, from the first device, a second message requesting data for the first device to determine whether to issue the one or more requests; and
transmit, to the first device, the data.

16. The apparatus of claim 10, wherein the processor is further configured to:
receive, from the first device, a second message requesting virtualization access for the first device; and
transmit, to the first device, the first message indicating configuration information for the first device.

17. A method performed by an apparatus, the method comprising:
receiving, from an operations and management entity, a first message indicating configuration information for an apparatus implementing the method, the configuration information including an indication of how to issue one or more requests to effect one or more changes in one or more virtual resources assigned to one or more second apparatus; and
issuing, in response to one or more conditions being detected, the one or more requests.

18. The method of claim 17, wherein the configuration information includes one or more of:
an address of a requesting entity where the apparatus sends the one or more requests;
authentication details for the apparatus to provide when requesting the one or more changes; and
a command to use to request the change.

19. The method of claim 17, wherein issuing the one or more requests comprises transmitting, to a requesting entity, a second message indicating to change a configuration of virtual resources assigned to the one or more second apparatus.

20. (canceled)

21. A method performed by an apparatus, the method comprising:
generating configuration information for a first device, the configuration information including an indication of how to issue one or more requests to effect one or more changes in one or more virtual resources assigned to a second device; and
transmitting, to the first device, a first message indicating the configuration information for the first device.
